(19) United States
(12) Patent Application Publication
(10) Pub. No.: US 2012/0310892 A1
(43) Pub. Date: Dec. 6, 2012

(54) SYSTEM AND METHOD FOR VIRTUAL CLUSTER FILE SERVER

(76) Inventors: Tru Q. Dam, Maple Grove, MN (US); Shanthi Paladugu, Plymouth, MI (US); Ravi K. Kavuri, Inver Grove Heights, MN (US); James P. Hughes, Herndon, VA (US)

(21) Appl. No.: 13/276,584

(22) Filed: Oct. 19, 2011

Related U.S. Application Data
(63) Continuation of application No. 11/018,047, filed on Dec. 21, 2004, now abandoned.

(51) Int. Cl. G06F 17/30

(52) U.S. Cl. 707/659; 707/E17.005

(57) ABSTRACT

A system for object-based data storage includes a plurality of object-based storage nodes having respective data storage devices, at least one file presentation node, a virtual cluster file server (VFS), and a scalable interconnect to couple the virtual cluster file server to the storage nodes, and to the at least one file presentation node. The VFS mirrors a same data object for a data file across the plurality of data storage devices.

### CROSS-REFERENCE TO RELATED APPLICATION

This application is a continuation of U.S. application Ser. No. 11/018,047 filed Dec. 21, 2004, which is hereby incorporated by reference in its entirety.

### BACKGROUND OF THE INVENTION

1. Field of the Invention

The present invention relates to a system and a method for a virtual cluster file server in a data storage system.

2. Background Art

Traditional (i.e., conventional) data file storage systems have four main focus areas, free space management, access control, name and directories (i.e., name space management) and local access to files. As data grows exponentially over time, storage management becomes an issue for all Information Technology (IT) managers. When a storage area network (SAN) is deployed, managing storage resources efficiently becomes even more complicated.

Referring to FIG. 1, a diagram of a typical Lustre (or LUSTRE) cluster data storage system 10 is shown. Lustre is a storage and file system architecture and implementation suitable for very large clusters. The name Lustre is an association of Linux and Clusters. Lustre is Open Source software developed and maintained by Cluster File Systems, Inc., Cluster File Systems, Inc., 110 Capen St., Medford, Mass. 02155, USA, under the GNU General Public License. The conventional Lustre cluster file system 10 is typically implemented to provide network-oriented environments a scalable and network-aware file system that can satisfy both data storage requirements of individual systems and the data sharing requirements of workgroups and clusters of cooperative systems.

The Lustre system 10 has three major components, the clients 12a-12n, the Object Storage Targets (OST) 14a-14n (coupled to respective data storage 16a-16n), and the meta-data servers (MDSs) 20a-20n (coupled to meta-data storage 22) that are interconnected via one or more GigE (i.e., gigabit Ethernet) interface structures (i.e., cables, switching, etc.). Each Lustre client 12 is a subsystem that traps file system calls such as read, write, lseek, and the like, and generates file I/O requests. The Lustre MDS 20 is a subsystem that manages the namespace for the file system 10, provides persistent storage for the file meta-data, stores the meta-data for file objects such as size, location, etc., holds only the references to the data objects and handles locking for meta-data operations. The Lustre OST 14 is a subsystem that stores the actual data objects, handles block allocations for file objects and handles locking for file I/O operations on the objects that are stored. The subsystems 14 and 20 interact with each other using Portals Application Program(ming) Interface (API).

A typical Lustre deployment (e.g., the system 10) will require each server to install a Lustre client subsystem 12 in order for the client to communicate with the MDSs 14 and OSTs 16. Up to 10,000 clients 12 can be supported in a Lustre environment. However, deficiencies in Lustre deployment include potentially costly requirements within a deployment for the clients to change existing systems and to develop new OST drivers for existing systems, and a lack standardization of the Universal User Identity (UUID) that identifies each node.

Further, data objects in an object-based storage system such as the system 10 are mirrored across multiple storage devices (e.g., the devices 16) and should be backed up for reliability and availability improvement. However, the object identifier for the mirrored object can be difficult to determine and to back up using conventional approaches.

Thus there exists an opportunity and need for an improved system and method for a data storage systems that does not require installation of any additional subsystem on any client, and that is scalable, reliable and expandable.

### SUMMARY OF THE INVENTION

The present invention generally provides a system and a method for new, improved and innovative techniques for a data storage system that addresses deficiencies in conventional approaches. The improved system and method of the present invention generally provides a virtual cluster file system in which the deployment of the cluster file system is transparent to the existing clients, data object mirroring across multiple storage devices, and data object back up.

According to the present invention, a system for object-based data storage is provided. The system comprises a plurality of object-based storage nodes having respective data storage devices, at least one file presentation node, a virtual cluster file server (VFS), and a scalable interconnect to couple the virtual cluster file server to the storage nodes, and to the at least one file presentation node. The VFS mirrors a same data object for a data file across the plurality of data storage devices.

Also according to the present invention, a method of managing data storage at a file level is provided. The method comprises interconnecting a plurality of object-based storage nodes having respective data storage devices, at least one file presentation node, and a virtual cluster file server (VFS) using a scalable interconnect, and mirroring a data object for a data file across the plurality of data storage devices when the data object is generated using the VFS.

Further, according to the present invention, for use in an object-based data storage system, a virtual cluster file server (VFS) is provided. The server comprises interconnections to scalably couple a plurality of object-based storage nodes each having at least one respective data storage device, and at least one file presentation node, and a translator that receives requests from external clients, translates the requests to kernel file system calls, traps the file system calls, and translates the file system calls to VFS file input/output (I/O) requests to respective storage nodes. The VFS mirrors a data object for a data file across the plurality of data storage devices when the data object is generated.

The above features, and other features and advantages of the present invention are readily apparent from the following detailed descriptions thereof when taken in connection with the accompanying drawings.

### BRIEF DESCRIPTION OF THE DRAWINGS

FIG. 1 is a diagram of a conventional Lustre cluster data storage system;

FIG. 2 is a diagram of a high level system architecture of the present invention;

FIG. 3 is a diagram of a data storage system of the present invention; and

FIG. 4 is a diagram of an alternative representation of the data storage system of the present invention.

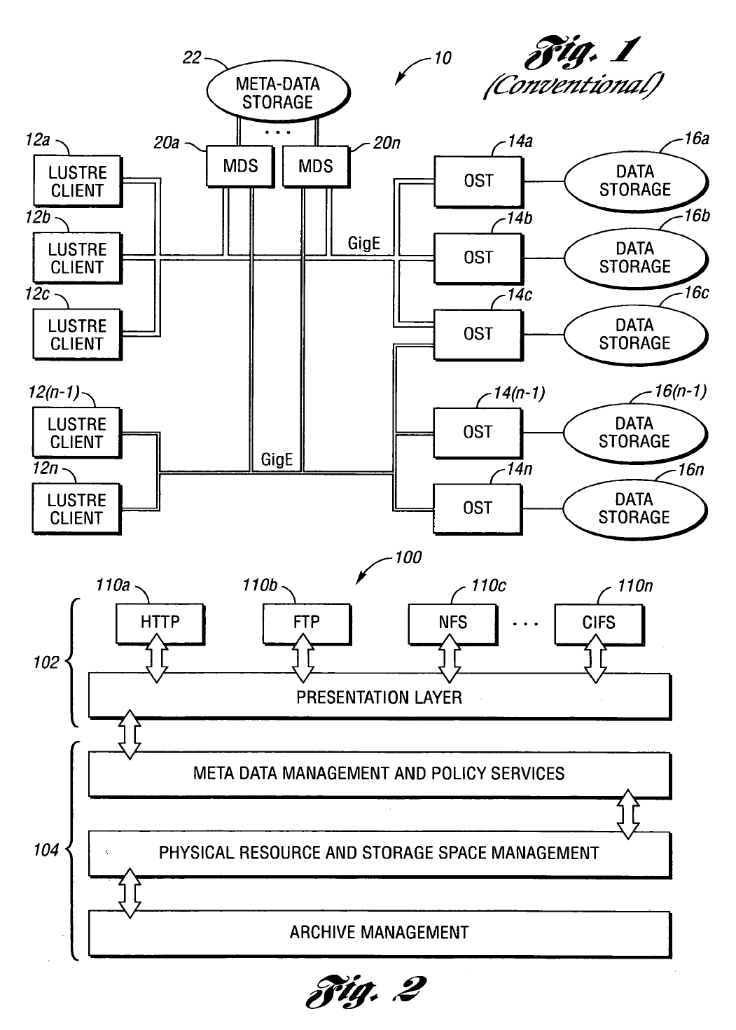

### DETAILED DESCRIPTION OF THE PREFERRED EMBODIMENT(S)

With reference to the Figures, the preferred embodiments of the present invention will now be described in detail. Generally, the present invention provides an improved system and method for new and innovative techniques for the implementation of data storage systems.

The following abbreviations, acronyms and definitions are generally used in the Background and Summary above and in the Description below.

### API: Application Program(ming) Interface

### CIFS: Common Internet File Services (Microsoft), Common Internet File System (Sun)

Data object: A file that comprises data and procedures (i.e., routines, subroutines, ordered set of tasks for performing some action, etc.) to manipulate the data.
Data striping: Segmentation of logically sequential data, such as a single file, so that segments can be written to multiple physical devices (usually disk drives) in a round-robin fashion. This technique is useful if the processor is capable of reading or writing data faster than a single disk can supply or accept the data. While data is being transferred from the first disk, the second disk can locate the next segment. Data striping is different from, and may be used in conjunction with, mirroring (see below).

### DMF: Data Management File

FS: File server(s)

### FTP: File Transfer Protocol

GNU: Self-referentially, short for GNUs not UNIX, a UNIX-compatible software system developed by the Free Software Foundation (FSF)
Hash: A function (or process) that converts an input (e.g., a input stream of data) from a large domain into an output in a smaller set (i.e., a hash value, e.g., an output stream). Various hash processes differ in the domain of the respective input streams and the set of the respective output streams and in how patterns and similarities of input streams generate the respective output streams. One example of a hash generation algorithm is Secure Hashing Algorithm-1 (SHA-1). Another example of a hash generation algorithm is Message Digest 5 (MD5). The hash may be generated using any appropriate algorithm to meet the design criteria of a particular application.
HSM: Hierarchical Storage Management, A self managing storage system of multiple hierarchies
HTTP: Hyper Text Transfer Protocol (World Wide Web protocol)
LUSTRE (or Lustre): An association of the words Linux and Clusters. Lustre is a storage and file system architecture and implementation suitable for very large clusters. Lustre is Open Source software developed and maintained by Cluster File Systems, Inc., Cluster File Systems, Inc., 110 Capen St., Medford, Mass. 02155, USA, under the GNU General Public License.
MDS: Meta-data server
Meta-data: Data about data. Meta-data is definitional data that provides information about or documentation of other data managed within an application or environment. For example, meta-data would document data about data elements or attributes, (name, size, data type, etc) and data about records or data structures (length, fields, columns, etc) and data about data (where it is located, how it is associated, ownership, etc.). Meta-data may include descriptive information about the context, quality and condition, or characteristics of the data.
Mirroring: Writing duplicate data to more than one device (usually two hard disks), in order to protect against loss of data in the event of device failure. This technique may be implemented in either hardware (sharing a disk controller and cables) or in software. When this technique is used with magnetic tape storage systems, it is usually called “twinning”

### NFS: Network File Server (or System)

### OST: Object Storage Target(s)

SAMBA (or Samba): A suite of programs running under UNIX-like operating systems that provide seamless integration between UNIX and Windows machines Samba acts as file and print servers for DOS, Windows, OS/2 and other Server Message Block (SMB) client machines Samba uses the SMB protocol which is the underlying protocol used in Microsoft Windows networking. For many networks Samba can provide a complete replacement for Windows NT, Warp, NFS or Netware servers. Samba most commonly would be used as a SMB server to provide Windows NT and LAN Manager style file and print services to SMB clients such as Windows 95, OS2 Warp, smbfs and others. Samba is available for a number of platforms such as AIX, BSDI, Bull, Caldera, Debian, DigitalUnix, IRIX, OSF, SCO, Slackware, SuSE, TurboLinux, HP, MVS, Novell, RedHat, Sinix, Solaris, VMS, and others. Samba is available under GNU public license.

### UML: Unified Modeling Language (Object Management Group, OMG)

### UUID: Universal User Identity (or Identifier)

The system and method of the present invention generally provide object-based storage having improved reliability and availability when compared to conventional approaches. The object-based storage of the present invention generally provides mirroring across multiple storage devices and back up using a virtual cluster file server (VCFS or VFS). Each file in the object-based storage of the present invention generally includes the file meta-data and the file data objects. The data objects are generally mirrored (i.e., duplicated, replicated, copied, etc.) across all appropriate multiple, respective data storage devices.

The data storage system and method of the present invention generally provides a new concept for a virtual cluster file system for user management of data storage at the file level that does not require any change to existing systems. The present invention generally deploys a modified Lustre file system in the back-end and adds several new enhanced features for users management of file storage. The data storage system and method of the present invention is generally scalable and expandable for future enhancements.

When a data object is created (i.e., generated, made, produced, etc.), the data object is generally assigned a global unique identifier, id, (GUID) by the VFS. When a data object is mirrored, the mirrored object has the same object id as the original data object. The object id (i.e., identifier) and the location (in storage) of the object identify the object itself. All mirrored objects of the data object have the (i.e., an identical) object id. The identical object id generally reduces or eliminates the task of bookkeeping and mapping between a file and the respective data objects. The system and method of the present invention generally provides users a scalable file-level storage solution that may also prepare the storage system implemented by the user for the implementation of further object-based storage devices.

The mirroring process that is implemented in connection with the present invention is generally performed by the VFS at the time the objects are created/updated. Performance of the present invention is generally substantially the same when parallel processing is applied to the mirroring process. That is, when a portion of data is written to a data object, the portion of data is generally additionally written on all mirrored objects of the data object. When a data object is modified, the respective mirrored objects are modified. Information regarding the mirrored data objects is saved in the file (i.e., data object) meta-data. Mirrored objects may also be implemented to provide load balancing.

All data objects are assigned version one when created. After a data object has been backed up, when a modification is performed on the data object, the data object is assigned a new version that is incremented by one from the prior version. To reduce or eliminate the task of back up redundancy, data objects having a new (i.e., not a prior) version are generally updated. Information regarding the versions of the data objects is saved in the file (i.e., data object) meta-data. Implementation of versions of data objects generally provides users the opportunity to choose the desired version of data object to access.

The present invention generally of the present invention generally provides a system and method for a virtual cluster file server system in which the deployment of the cluster file system is transparent to the existing clients. The VFS can be plugged (i.e., implemented) in any environment and is not limited to any additional subsystem being installed on any client. In one example, the virtual cluster file server of the present invention generally uses modified Lustre as the base along with other open-source file server protocols such as HTTP, NFS, CIFS, etc. In the modified Lustre base of the present invention, the OST and NFS can co-exist in handling data objects. The VCFS of the present invention generally has additional features that efficiently improve storage utilization and storage management such as file mirroring, detection/compaction of files with same contents, and object-based tape and file backup management.

The VFS deploys the modified Lustre as the base for the back-end file system, stores data objects on existing file servers and communicates with existing clients using the appropriate file server protocols. The virtual cluster file server is generally scalable, reliable and expandable. The VCFS does not require any specific hardware design. In one example, the virtual cluster file server of the present invention generally can be installed on any Linux server. In another (i.e., alternative) example, the virtual cluster file server of the present invention may be implemented on special platforms. The VFS of the present invention may also deploy a networking storage environment in the back end of the data storage system that is transparent to the front-end clients.

The data storage system and method of the present invention generally creates a cluster file system that will allow hundreds of nodes to share the same name space, integrate HSM movement of data without application knowledge, and extensible meta-data. The data storage system and method of the present invention generally provides for applications to run on any node in the system, reliable failover, and removal of significant complexity from applications. The data storage system and method of the present invention further provides for file level presentation that includes global name space, and presentation of FS in an environment that is generally understood by a customer.

The data storage system and method of the present invention generally provides for hierarchical storage management that includes automated migration and replication across various physical media and integrated backup and archival, meta-data management that includes separation of name and free space management and content based storage policies, and scalability that includes the global name space, the physical storage and hierarchy, and the local and remote interconnect.

The presentation layer implemented using the system and method of the present invention generally provides for a name space that is unified across all presentation nodes, preservation of access rights and policies across the entire presented space, and file level services, not a new file system. The presentation layer implemented using the system and method of the present invention further provides for all forms of protocol access to the same data (e.g., HTTP, FTP, NFS, CIFS, etc.) and a conventional VFS layer to trap file operations.

Hierarchical storage implemented using the system and method of the present invention is not a mainframe HSM as used in conventional approaches. Rather, the present invention provides for distribution of storage across storage nodes, distribution of storage with in a storage node in a hierarchical fashion, replication within and across storage nodes, and migration within or across storage nodes.

Meta-data management of the present invention generally includes an MDS that captures all meta-data related to a named object, Access control lists (ACLs) that contain name and directory information, mapping and translation of named objects to managed objects, policy based placement of named object into a hierarchy, policy based replication and movement of managed objects, and unique content based identifiers created (i.e., generated, produced, etc.) and updated with file operations.

The data storage system and method of the present invention generally provides scalability on the presentation nodes, the storage nodes, and the interconnect between nodes. The data storage system and method of the present invention further provides for networked file system based content distribution, and an integrated hierarchy of data placement within and across storage nodes based on policy of presented named objects.

The data storage system and method of the present invention further generally includes a meta-data server (MDS) that generally provides mapping and translation of named objects to managed objects, policy based placement and migration of managed objects across and within a storage node, content signature of named objects, and detection and notification of duplicate named objects based on content signature

The data storage system and method of the present invention further generally includes presentation of a global namespace to all hosts external to the data storage system, maintenance of a back-end cluster file system (e.g., a LINUX based, modified Lustre cluster file system), separate meta-data and data for a file which provides data location independence, use of NFS to handle object data files, file backup/restore performed transparently to hosts, and detection of files with identical contents based on (i.e., in response to) MD5 checksum and size.

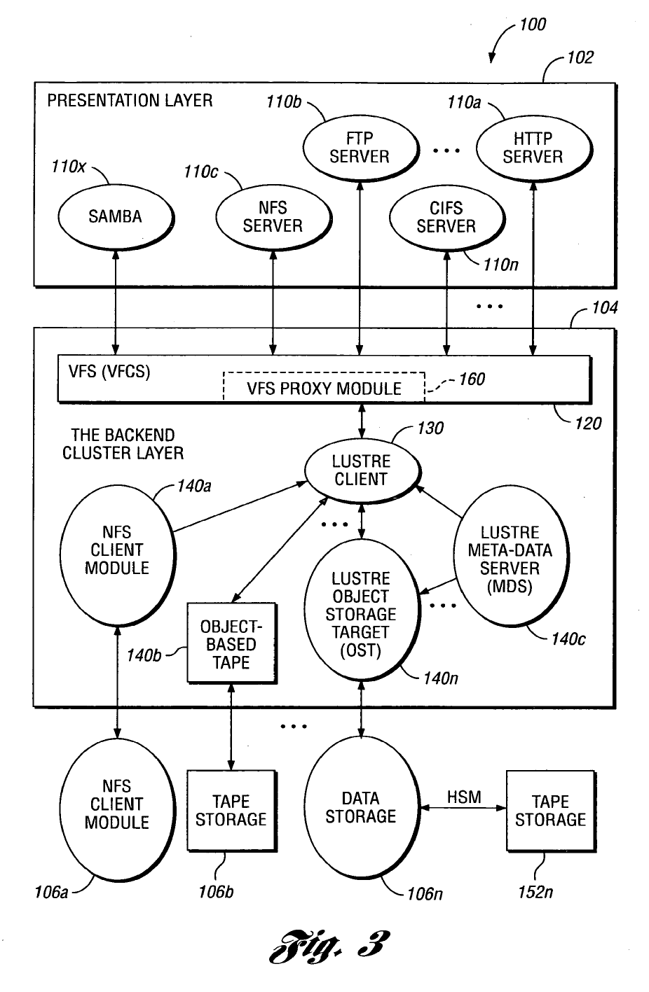

The data storage system and method of the present invention generally provides two layers that are described in detail in connection with FIGS. 2-4. The layers are a presentation layer and a back-end system layer (i.e., an enhanced Lustre file system layer). Hosts external to the data storage system generally communicate with the presentation layer to access the global file system. The back-end layer generally handles (i.e., performs) file manipulation.

Referring to FIG. 2, a diagram of a high level system architecture of a system 100 the present invention is shown. The system 100 is generally implemented as a scalable data storage system. The system 100 generally comprises a presentation layer 102 coupled to a back-end layer 104. The presentation layer 102 is generally configured to receive file requests from hosts (not shown) and translate the requests to file requests (e.g., VFS file requests) that are processed by the back-end layer 104. The presentation layer 102 generally includes at least one file server 110 (e.g., file servers 110a-110n) that interfaces to external clients (not shown) and implements protocols such as HTTP, FTP, NFS, CIFS, and any other appropriate protocol to meet the design criteria of a particular application.

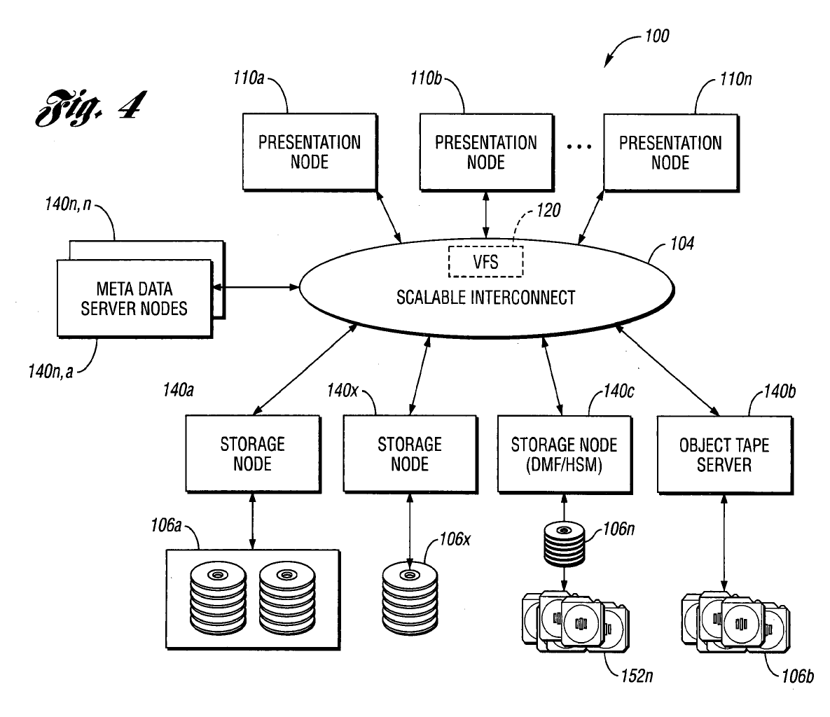

The back-end layer 104 is generally implemented as an enhanced (i.e., improved, augmented, modified, etc.) Lustre file system. The back-end layer 104 generally performs meta-data management and policy services, physical resource and storage space management, and archive management. As described in more detail in connection with FIGS. 3 and 4, the back-end layer 104 generally includes a VFCS client, a Lustre-based MDS, and NFS back-end file systems. The layer 104 is generally implemented as an interconnect (e.g., mesh). The VFCS client (e.g., a VFS proxy) generally traps VFS calls and translates the calls to Lustre/NFS file requests. The Lustre MDS manages file meta-data, and the NFS back-end file systems handles file data (object files). The VFCS client of the present invention is generally enhanced to provide from a user standpoint at least one of transparent file backup/restore operations, transparent file mirroring, file restoration as appropriate, file backup/migration based on predetermined backup/migrate policy, duplicate file detection, computation of hash (e.g., MD5) checksum on each file and save of the checksum in the respective meta-data for the file, and detection of files having the same contents based on hash checksums and sizes.

Referring to FIG. 3, a diagram of the data storage system 100 of the present invention is shown. The system 100 includes the presentation layer 102, the back-end layer, and at least one storage device 106 (e.g., devices 106a-106n) coupled to the back-end layer 104. The devices 106 may be implemented as network file server (NFS) data storage devices (e.g., device 106a), tape storage (e.g., device 106b), disk storage (e.g., device 106n), and the like. Further, at least one disk storage may be coupled to additional tape storage (e.g., tape storage 152n) via hierarchical storage management (HSM).

The back-end 104 generally includes a VFS (i.e., VCFS client) 120 coupled to a Lustre client 130, and at least one module (e.g., an NFS client module 140a, an object-based tape module 140b, a Lustre MDS 140c, a Lustre OST 140n, and the like) coupled to the Lustre client 130. Each module 140 is generally coupled to a respective data storage device 106 (e.g., the NFS client module 140a may be coupled to the NFS data storage 106a, the object-based module 140b may be coupled to the tape storage device 106b, etc.). The Lustre MDS is generally coupled to the Lustre client 130 and to the Lustre OST 140n.

The VFS 120 generally comprises a VFS proxy module 160 (e.g., enhancement) that is coupled to the Lustre client 130. The VFS proxy module 160 generally performs meta-data management and policy services, physical resource and storage space management, and archive management.

Referring to FIG. 4, a diagram of an alternative representation of the data storage system 100 of the present invention is shown. The back-end 104 may comprise a scalable interconnect having a plurality of nodes (e.g., presentation nodes 110 and server/storage nodes 140). The MDS 140n may be implemented as at least one MDS (e.g., MDS 140n,a-140n,n). At least one disk storage device (e.g., device 106x) may be implemented without a respective tape storage device.

The data storage system and method of the present invention generally includes at least one presentation node (e.g., nodes 110a-110n). Such presentation nodes may be implemented as a UML node that is contained in the presentation layer 102. A number of servers (e.g., servers 140a-140n) may be installed (e.g., user-space NFS, APACHE, SAMBA, WU-FTP, etc.) as respective nodes. The presentation node generally contains the modified-Lustre client component that is mounted in a respective directory. The primary object files and the respective mirrored object files are stored in respective locations (e.g., devices 106).

The NFS directories are generally mounted on the presentation node 102. The meta-data node (i.e., MDS node 140c) is generally a UML node that contains the modified-Lustre MDS component and holds meta-data related to the file system 100. The NFS primary data node 140a may be implemented in connection with a Linux machine that contains respective directories that are exported via NFS (e.g., to the device 106a). The data portion of the primary object of a file is generally saved in one of the respective directories.

The virtual cluster file server (VCFS) or virtual file server (VFS) 120 may be implemented as a “black box” (i.e., transparent to the user of the system 100) that handles file requests from clients using appropriate file protocol. The VFS 120 generally stores and manages the files efficiently using modified Lustre as the back-end cluster file system without upgrade requirements on the clients. Any existing file server and file protocol may be installed in the system 100 and may communicate with the VCFS.

The presentation layer 102 comprises all file server protocols that the VCFS 120 supports such as Samba, HTTP, NFS, etc. The file server protocols receive requests from the clients (not shown) and translate (e.g., via a translator, such as the VFS proxy 160) the requests to kernel file system calls. The file system calls are generally trapped by the VCFS client and translated (e.g., via the translator) to VCFS file input/output (I/O) requests. Multiple VCFSs can generally access the same cluster file system. The cluster file system layer 104 generally comprises the back-end modified Lustre file system that includes the VCFS client module 120, one or more MDS modules 140c, one or more OST modules 140b, and NFS-support file servers 140a. The MDS subsystems 140c and OST subsystems 140n can reside on the server 104 itself (as shown in FIG. 3) or, alternatively, on a cluster file network (as shown in FIG. 4).

In addition to the advantages derived from the back-end Lustre cluster file system, the VCFS 120 generally provides additional advantages and enhancements for efficient management of the file storage. The first enhancement is a file mirroring operation. The second enhancement is a detection/compaction operation of data objects having the same contents. The third enhancement is an automatic file archive operation. The fourth enhancement is providing for object-based tape (OBT) data storage.

The virtual cluster file server (VCFS) 120 generally provides for storage of data objects both as an OST object and as an NFS data object. The meta-data of a file is generally expanded to include information about the data objects and the type of data object. The MDS 140c generally performs the task of assigning data object ids for NFS data objects to ensure uniqueness. Each data object is generally saved (or stored) as an NFS file in a flat NFS directory. The data object id is the name of the corresponding NFS data file. The decision to save data objects as OST objects or NFS objects is generally based on pre-defined (i.e., predetermined) file policies that are transparent to the front-end (i.e., presentation layer) clients. The front-end clients are generally unaware of the existence of data objects.

The NFS directories that are used to store data objects are generally defined at startup time. Each NFS directory is generally processed as an OST is processed. Data striping may also be applied on NFS data objects. Generally, both OST and NFS data objects may co-exist under the same file.

The data storage system and method of the present invention generally provide at least one of the following behaviors.

(i) When data is written to a primary object file, the written data is also mirrored to the respective mirrored object file.
(ii) When access to the primary object file fails, the mirrored object file is used instead.
(iii) When primary object file and mirrored object file are not in sync (i.e., contain the same data), a repair process will generally attempt to restore sync.
(iv) When a file is created/modified, a hash checksum (e.g., an MD5 checksum or the like) is computed and saved in the meta-data for the file.
(v) A background task may examine the hash checksums, and detect files having the same contents.
(vi) Duplicate mirrored object files and even primary files may be deleted when requested by the user.
(vii) Information about hash checksums may be dumped into a respective text file.

Example operations of the system (e.g., the system 100) and method of the present invention may be performed as in the following test cases.

Test case 1
Create a file named “foo”

### Results:

a primary object file is created in one directory of the primary data node and a mirrored object file is also created in one directory of the mirror data node an MD5 checksum is computed for “foo” and is displayed in the dumped text file

Test case 2
Copy file “foo” to file “fool”

### Results:

a primary object file is created in one directory of the primary data node for “fool” and a mirrored object file is also created in one directory of the mirror data node

an MD5 checksum is computed for “fool” and is displayed in the dumped text file. The display shows that “foo” and “fool” having the same MD5 checksum.

Test case 3
Delete file “foo”

### Results:

“foo” is deleted from the current file system

Both primary object file and mirrored object file of “foo” are also deleted

Test case 4
Unmount the NFS directory that stores the primary data object of “fool” then read data from “fool”

### Results:

Data should be read successfully from the mirrored object of “fool”.

Test case 5
Mount the NFS directory of primary object of “fool” after deleting that primary object. Read data from “fool”.

### Results:

Data should be read successfully from the mirrored object of “fool”.

Repair process takes place which should copy data from the mirrored object back to the primary object of “fool”.

File backup may be based on criteria such as how long the file has been created, how long the file has not been accessed, etc. A service policy to provide immediate backup after creation/modification (e.g., mirroring) may be implemented. The present invention generally provides migration of data (e.g., across storage devices 106a-106n), repair data in case of communication failures, and compact storage space by having files with the same data contents refer to only one object file and thus free the duplicates. For example, migration may apply only to backup object files, apply to both backup object files and primary object files, etc. The present invention may further provide data back up to tape via object-based tape.

Examples of procedures to process the NFS/OST data objects using the system 100 and method of the present invention may be implemented as follows.

a) Open a file

Upon receiving an open request, the VCFS client 120 generally checks to determine whether the file exists or does not exist. When the requested file does not exist, either an OST object or an NFS object is created (i.e., generated, produced, etc.).

When a new NFS object is created, the VCFS client 120 generally acquires the object ID and the associated NFS directory from the MDS 140c. When an OST object is created, the OST 140n generally determines the OST object ID. Information regarding the data objects may be saved in the meta-data for the file.

When a file is opened, the respective associated data object is also opened. When the opened file is an OST object, an open request is issued to the OST 140n. When the opened file is an NFS object, an NFS open request is sent to the corresponding NFS server 140a.

b) Close a file

Upon receiving a close request, the VCFS client generally closes the data object for the file and updates the meta-data for the file accordingly. When the data object is an OST object, a close request is generally issued to the OST. When the data object is an NFS object, the corresponding NFS data object is generally closed.

c) Read a file

Upon receiving a read request, the VCFS client generally reads from the corresponding data object associated to the file. When the data object is an OST object, a read request is generally issued to the OST. When the data object is an NFS object, an NFS file read operation is generally performed on the object itself.

d) Write to a file

Upon receiving a write request, the VCFS client generally writes to the corresponding data object associated to the file. When the data object is an OST object, a write request is generally issued to the OST. When the data object is an NFS object, an NFS file write operation is generally performed on the object itself.

e) Delete a file

Upon receiving a delete request, the VCFS client generally deletes the corresponding data object associated to the file. When the data object is an OST object, a destroy request is generally issued to the OST. When the data object is an NFS object, an NFS file unlink operation is performed on the object itself.

File mirroring is generally implemented to increase data redundancy and provide for quick recovery from failures. Because data is stored in data objects that are associated to a file, the same data can be written on mirrored data objects that are also associated to the respective file. The meta-data of the file is generally expanded to include information about both the respective primary data objects and mirrored objects.

When a file is open, both of the respective primary object and mirrored object are opened. When a file is closed, both objects are closed. When data is written to the file, the same data is generally written on both primary and mirrored objects. When data is read from the file, data is generally read only from one object, rather than both objects. When a file is deleted, both primary and mirrored objects are also generally deleted.

When access to one object is failed, data may be recorded/retrieved successfully onto/from the other (alternative) object. The primary object and mirrored objects are considered out-of-sync when data can not be written successfully on one or the other. The meta-data of the file generally records the status, and a repair process can be performed at a later time to bring both objects back in sync. During the out-of-sync time period, file read/write operations are generally performed on the “good” (i.e., non-failed) object only.

The file mirroring feature may be alternatively applied on files based on the management policies for the files. Primary and mirrored objects may be interchangeable. In other words, both objects can be considered to be the same. Load balancing for read operations may be applied in the objects when the objects are the same.

The file mirroring feature of the present invention may follow the procedures (i.e., operations, steps, etc.) as follows.

i) Open a file

Upon receiving an open request, the VCFS client generally checks to determine whether the file exists or the file does not exist. When the file does not exist, both primary and mirrored objects are generally created.

Information regarding the data objects such as the respective ids, statuses, etc. is generally saved in the meta-data for the file.

When a file is opened, associated primary and mirrored data object for the file are generally also opened. A file is considered opened when at least one “good” data object is opened.

ii) Close a file

Upon receiving a close request, the VCFS client generally closes both the primary and mirrored data object for the file and update the meta-data for the accordingly.

When the data objects are not in sync, the VCFS client attempts to bring the objects back in sync (i.e., repair the “bad”, failed, defective, etc. object) by copying data from the “good” object to the “bad” object. When the repair is successful, both objects are back in sync and the respective statuses are generally updated accordingly.

iii) Read a file

Upon receiving a read request, the VCFS client generally reads from either the primary or mirrored data object for the file. Data is generally read only from “good” object.

Load balancing may be applied during the read operation to provide for data to be read from either of the primary or the mirrored data object.

When the read operation fails in the primary object, the same read operation may be performed on the mirrored object substantially instantaneously.

iv) Write to a file

Upon receiving a write request, the VCFS client generally writes to both the primary and the mirrored data objects associated to the file. When the write operation fails in one object, that object is considered “bad” and no more file operations are generally performed on that object until the “bad” is bought back to “good” (i.e., repaired). A write operation is generally successful when the write is successful on at least one object.

The write operation may be performed in parallel on each data object to reduce overheads.

v) Delete a file

Upon receiving a delete request, the VCFS client generally deletes both the primary and mirrored data object associated to the file.

Detection/compaction operations may be performed on files having the same contents. File copy management becomes a nuisance for storage management when multiple copies of the same file are scattered all over the storage space. When the file size is large (e.g., in multiple gigabytes), storage waste is often a significant deficiency of conventional data storage systems. Storage waste has been addressed at a user level using tools such as UNIX soft links but storage waste is not addressed yet at file system level using conventional approaches.

The VCFS 120 of the present invention cures the storage waste deficiency transparently at the file handler level. Each file is generally associated to a hash value obtained (i.e., generated, produced, calculated, etc.) when the file is completely committed (i.e., all related information is generated and data is stored in the file). The hash value generally remains fixed unless modification is performed on the file. The hash value is generally stored as an attribute of the meta-data for the file in the MDS. When a file is completely committed, the respective hash value may be compared to the existing hash values. When a matching hash value exists in the MDS, the files are compared to each other using file size and then file difference. When the compared files are the same, the new file object may be erased from the storage space and the metadata of the new file name is generally updated to refer to the old file object.

A file object is generally erased only when no references are made to the object file. A modified file will generally be written as a new file object and the meta-data for the file will be updated accordingly. The detection/compaction process of files with same contents feature takes advantage of the fact that the meta-data for the files is separated from the data object itself. The meta-data generally only holds reference to the data object, and therefore, the meta-data can be manipulated to make file storage more efficient. The detection/compaction feature will be greatly enhanced when a new system call is used for file copy instead of a series of read and write calls.

The detection/compaction feature generally reduces the overhead of writing down the new file and erasing the new file eventually when the new file is exactly the same as one of the existing files. In order to reduce the overhead of unnecessary file comparison, the hash function is generally adequate to generate distinct hash values for files that are different from each other. In order to reduce the hash value search time, hash buckets are generally used. In order to avoid impact on I/O performance, the detection/compaction operation can take place in the background task at any time desired by the user.

Each file generally has a meta-data record that maintains a reference to data object(s) for the file. The meta-data record is generally kept (i.e., held, contained, etc.) in the Lustre MDS 140c. In addition to Lustre attributes, each file also generally maintains a meta-data record that contains a hash value associated to the file. When a file is closed and when the file is dirty (i.e., a data modification is performed on the file), the MDS 140c will generally perform a hash function on the file. The resultant hash value associated to the file is generally saved in the meta-data record for the file. The hash function can be the simple MD5 checksum function or any sophisticated hash function to meet the design criteria of a particular application. The range of the hash value is generally predetermined to be large enough to accommodate a large number of files (in the billions of files range). The hash values for the files are generally sorted and saved in a hash table (not shown).

Each file data object also maintains a record of the number of references that refer to the file.

The system and method of the present invention generally includes a background task which examines all hash buckets and find files that have the same size and the same hash value. When files are determined to have the same size and the same hash value, the background task will compare the files. When the files are the same, a primary file object is generally selected based on certain criteria such as the number of references associated to the primary file object, when the primary file object was created, etc. All meta-data records that refer to a copy of the primary file object will generally be updated to refer to the primary file object. The reference counts of all respective file data objects are updated accordingly. The background task also generally examines all file data objects. Any file data objects that have no references to the file will be eventually erased from associated storage space for the file.

The following procedure describes one example of how a file is saved according to the present invention.

(a) Client sends fclose( ) command.
(b) The VCFS client writes data onto the data storage file and computes the hash value associated to the file based on the file data.
(c) The VCFS client sends to the respective MDS the hash value associated to the file along with other information such as file size, etc.
(d) The MDS saves the hash value in the hash table and in the meta-data record for the file.

The following procedure describes one example of how the background task operates according to the present invention.

(a) At a pre-determined time, the background task checks all hash buckets to determine whether there are any buckets that contain files that have the same size and same hash value.
(b) When there are any buckets that contain files that have the same size and same hash value, the data from both files are generally read and compared.
(c) When both files are the same, the background task generally chooses one of the data object to keep. Usually, the data object having the larger number of references will be chosen. The meta-data record of the duplicate file will be updated to refer to the primary data object of the file instead of the duplicate file. The references on all of the data objects are also updated accordingly.
(d) The background task generally checks to determine when there are any file objects that have reference count of 0.
(e) When such a file object exists, that file object is generally deleted from the file storage. When a file object has a reference count of 0, a data object does not exist in any MDS meta-data record. The recovery process generally accounts for the reference count. The background task may be activated as an alternative of the VCFS 120.

As described above, the backup of files may be processed in the back-end file system of the VCFS 104 without an additional backup application. Each file generally has an associated backup-information record. The backup-information record generally includes information regarding how the backup of the file is generally performed. The backup-information record generally includes information regarding when and where the file should be backup-ed, for what time duration or period the primary data should be valid, for what time duration or period the back-up data should be valid, how many backups should be created for the file, etc. The backup-information record is generally input from the users and saved in the MDS 140c.

Each file also has an attribute in the meta-data record (e.g., an attribute named backup-data-object) that refers to the backup data object. The meta-data record may perform as an extension of the file mirroring feature to satisfy backup criteria.

A backup process may be running on the background of the Lustre client in which the backup process requests backup information from the MDS 140c, performs the desired data mirroring, and updates the backup data object reference accordingly. The backup data object is generally processed the same as the primary data object.

When the OST (e.g., an OST 140b) that contains the primary data object fails, the MDS 140c may use the back-up data object reference to retrieve file data instead when the backup data object is available. Multiple back-up data references may also be supported using the system 100 and the method of the present invention to increase availability.

The back up feature can generally be combined with the detection/compaction of files operation such that the same contents may be used to make use of duplicate files. Instead of erasing duplicate files from storage space, duplicate files can be used as backup reference if desired. Another application that may be implemented is to perform the compaction of data objects having the same contents on backup objects only. When a primary file data object expires, the primary data object reference is cleared but the backup data object reference may still be valid. A meta-data record is deleted only when all data references are invalid (i.e., NULL).

Another enhanced feature of the present invention is object-based tape in which file data objects are backup-ed onto tape instead of disk. A unique OST driver for tape may be implemented. Tape-oriented products such as a virtual transport manager (VTM) or tape mirroring can be supported as subcomponents in a object-based tape module.

As is readily apparent from the foregoing description, then, the present invention generally provides an improved method and an improved system (e.g., the system 100) for data storage that includes object-based storage having improved reliability and availability when compared to conventional approaches. The object-based storage of the present invention generally provides mirroring across multiple storage devices and back up using a virtual cluster file server (VCFS or VFS).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for object-based data storage, the system comprising:
a plurality of object-based storage nodes having respective data storage devices;
at least one file presentation node;
a virtual cluster file server (VFS); and
a scalable interconnect to couple the virtual cluster file server to the storage nodes, and to the at least one file presentation node, wherein the VFS mirrors a same data object for a data file across the plurality of data storage devices.

2. The system according to claim 1 wherein the data object and the mirrored data objects are assigned a global unique identifier (GUID) when the data object and the mirrored data objects are generated.

3. The system according to claim 1 wherein an object identifier and location of the object identify the object.

4. The system according to claim 1 wherein data that is written to the data object is further written to all respective mirrored objects, and the data object is incremented by one from the previous version, when the data object is backed up.

5. The system according to claim 1 wherein a hash value is generated when the data object is generated, and the hash value remains fixed unless modification is performed on the data object.

6. The system according to claim 5 wherein storage space compaction is performed by comparing hash values and when hash values match, comparing files and when files match, and erasing new file objects.

7. The system according to claim 1 wherein the VFS receives requests from external clients and translates the requests to kernel file system calls, the file system calls are trapped by the VFS and translated to VFS file input/output (I/O) requests to respective storage nodes.

8. The system according to claim 1 wherein the object-based storage nodes reside on the VFS.

9. A method of managing data storage at a file level, the method comprising:
interconnecting a plurality of object-based storage nodes having respective data storage devices, at least one file presentation node, and a virtual cluster file server (VFS) using a scalable interconnect; and
mirroring a data object for a data file across the plurality of data storage devices when the data object is generated using the VFS.

10. The method according to claim 9 further comprising assigning a global unique identifier (GUID) to the data object and the mirrored data objects when the data object and the mirrored data objects are generated.

11. The method according to claim 9 wherein an object identifier and location of the object identify the object.

12. The method according to claim 9 further comprising writing data that is written to the data object to all respective mirrored objects, and incrementing the data object by one from the previous version, when the data object is backed up.

13. The method according to claim 9 further comprising generating a hash value when the data object is generated, and fixing the hash value unless modification is performed on the data object.

14. The method according to claim 13 further comprising compacting storage space by comparing hash values and when hash values match, comparing files and when files match, and erasing new file objects.

15. The method according to claim 9 wherein the VFS receives requests from external clients and translates the requests to kernel file system calls, the file system calls are trapped by the VFS and translated to VFS file input/output (I/O) requests to respective storage nodes.

16. The method according to claim 9 wherein the object-based storage nodes reside on the VFS.

17. For use in an object-based data storage system, a virtual cluster file server (VFS), the server comprising:
interconnections to scalably couple a plurality of object-based storage nodes each having at least one respective data storage device, and at least one file presentation node; and
a translator that receives requests from external clients, translates the requests to kernel file system calls, traps the file system calls, and translates the file system calls to VFS file input/output (I/O) requests to respective storage nodes, wherein the VFS mirrors a data object for a data file across the plurality of data storage devices when the data object is generated.

18. The server according to claim 17 wherein the data object and the mirrored data objects are assigned a global unique identifier (GUID) when the data object and the mirrored data objects are generated.

19. The server according to claim 17 wherein a hash value is generated when the data object is generated, and the hash value remains fixed unless modification is performed on the data object.

20. The server according to claim 19 wherein data that is written to the data object is further written to all respective mirrored objects, and the data object is incremented by one from the previous version, when the data object is backed up.
